(19) United States
(12) Patent Application Publication
(10) Pub. No.: US 2011/0229296 A1
(43) Pub. Date: Sep. 22, 2011

(54) APPARATUS, SYSTEM AND METHOD FOR STORAGE AND DISPENSING OF ITEMS

(76) Inventors: Wes van Ooyen, Burlington (CA); Todd Willick, Mississauga (CA); Derek Bessette, Milton (CA); Richard Panetta, Milton (CA); Peter Suma, Aurora (CA)

(21) Appl. No.: 12/728,202

(22) Filed: Mar. 20, 2010

(51) Int. Cl. B65G 59/00; B65G 61/00; B25J 9/00; G06F 7/00; G06F 19/00

(52) U.S. Cl. 414/795.4; 414/801; 700/215

(57) ABSTRACT

A method and apparatus for picking items from a stack of items stored in one of a number of bins in a kiosk dispensary. Each bin has a bin identifier identifying its position in the rack and each bin accommodates one or more items with multiple items in a bin arranged in a stack. Each item in the stack has an order identifier corresponding to its position in the stack. An item to be picked is identified by its bin identifier and order identifier. Items between the item to be picked and an access position of the stack are removed from the stack and parked until the item to be picked is in the access position whereupon it is removed from the bin and an index of order identifiers and bin identifiers is updated to match the repositioning of the items.

### FIELD OF THE INVENTION

The invention relates to apparatus, systems and methods for storing and dispensing selected items.

### DESCRIPTION OF RELATED ART

Various automated storage and dispensing apparatus such as “pop machines” are known. Such devices typically are stocked with a limited selection of items of a standard size, the inventory and stocking of which is periodically monitored by a human attendant. These relatively simple machines are not suitable for dispensing items with more sophisticated requirements such as medicaments. The traditional means of dispensing prescribed medicaments involves a doctor meeting with a patient and prescribing a medicament based on a particular diagnosis, and then hand writing and signing a prescription for the patient to carry to a pharmacist at a pharmacy location for fulfillment. In recent years, two major advancements have occurred in the field of medicament dispensing. The first is the advent of electronic prescription capturing methods, systems and apparatus, which improve the overall accuracy and patient record-keeping associated with prescribing drugs. The second is the advent of automated apparatus, typically configured as kiosks, from which medicaments can be automatically dispensed, the kiosks being located for convenient patient access, such as at a doctor's premises, a hospital or mall. While such kiosks provide significant advantages, medicament packages typically vary significantly in size and shape and there remains a need to maximize the quantity and variety of packages within such size-limited kiosks while maintaining accuracy in automated order dispensing.

### SUMMARY OF THE INVENTION

In one embodiment, there is provided a method for picking an item from a storage apparatus. The storage apparatus includes a rack of bins, each bin having a bin identifier identifying its position in the rack. Each bin can accommodate one or more items and multiple items in a single bin are arranged in a stack and each item in a stack has an order identifier corresponding to its position in the stack. The method includes the steps of: a) identifying an item to be picked by its bin identifier and order identifier; b) removing items of the stack between the item to be picked and an access position of the stack and parking the removed items until the item to be picked is in the access position; c) removing the item to be picked; and d) updating an index of order identifiers and bin identifiers to match the repositioning of the items.

In another embodiment, a method of handling items at an automated dispensing is provided. The method includes the steps of: a) receiving an order for a selected item; b) picking the selected item according to an embodiment of the method of the present invention; and c) transferring the picked item to a user.

In another embodiment, a method for arranging items in a storage apparatus is provided. The storage apparatus includes a rack of bins, a pick head and a pick head driver for driving the pick head to an access position in a selected bin and a controller for receiving orders for items and signalling to the pick head driver to select items. The method includes the steps of: a) depositing items in selected bins, wherein when multiple items are deposited in a bin they are arranged in one or more stacks; b) assigning one access position to each stack; c) assigning each item a bin identifier corresponding to the location of its bin within the rack and an order identifier identifying the number of items between the item and the access position.

In another embodiment, an apparatus for storing and dispensing items is provided. The apparatus includes a rack of bins, each bin accommodating one or more items and where multiple items in a single bin are arranged in a stack. The apparatus further includes a pick head and a pick head driver for driving the pick head to an access position in a selected bin, wherein each item in a stack is assigned an order identifier corresponding to the number of items between it and the access position. The apparatus further includes an indexing module for storing for each item a bin identifier corresponding to the bin in which the item is positioned and an order identifier corresponding to the number order of the item in the stack in which the item is positioned. The apparatus also includes a controller for receiving orders for items and signalling the pick head driver to select an item by bin identifier and order identifier. The controller is operable to: a) identify a selected item to be picked from a stack thereof by a selected bin identifier and a selected order identifier; b) drive the pick head to remove items of the stack between the item to be picked and an access position for the selected bin and to park the removed items; c) drive the pick head to remove the item to be picked; and d) update an index of the order identifiers and the bin identifiers to match the repositioning of the items.

### DESCRIPTION OF THE DRAWINGS

For simplicity and clarity of illustration, elements illustrated in the following figures may not be drawn to common scale. For example, the dimensions of some of the elements are exaggerated relative to other elements for clarity. Advantages, features and characteristics of the present invention, as well as methods, operation and functions of related elements of structure, and the combinations of parts and economies of manufacture, will become apparent upon consideration of the following description and claims with reference to the accompanying drawings, all of which form a part of the specification, wherein like reference numerals designate corresponding parts in the various figures, and wherein:

FIG. 1 is a front view of a storage apparatus for a package dispensing kiosk suitable for use with the methods of the present invention;

FIG. 2 is a perspective view of a bin rack forming part of the storage apparatus of FIG. 1;

FIG. 3 is a perspective view of part of a back panel forming part of the storage apparatus of FIG. 1;

FIG. 4. shows one embodiment of bins of a storage apparatus of the present invention;

FIG. 5 shows one embodiment of bins of a storage apparatus of the present invention;

FIG. 6 is a schematic of one embodiment of bins of a storage apparatus of, the present invention showing one embodiment of order identifiers;

FIG. 7 is a flow chart illustrating a method for arranging items in a storage apparatus according to an embodiment of the present invention.

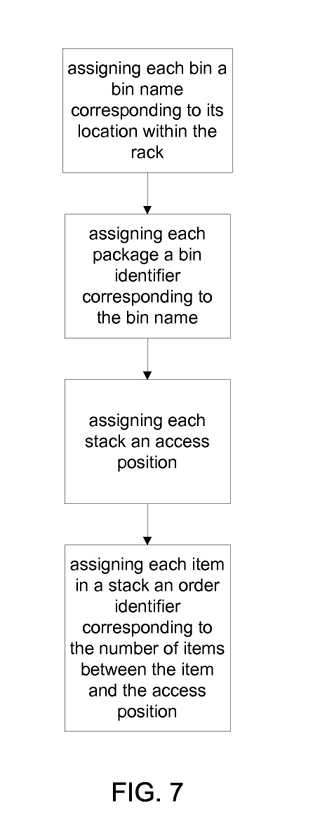

FIG. 8 is a flow chart illustrating a method for picking a selected item according to an embodiment of the present invention.

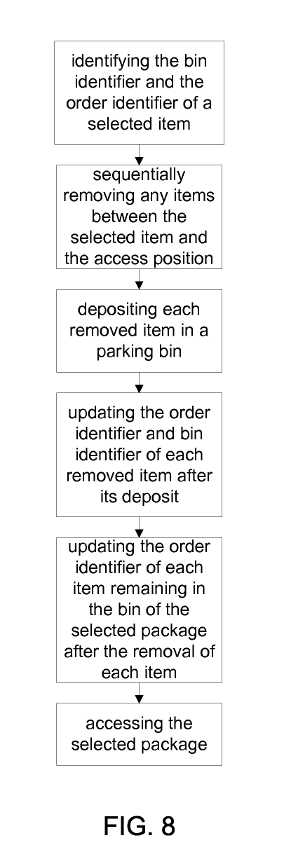

FIG. 9 is a flow chart illustrating a method for automated dispensing according to an embodiment of the present invention.

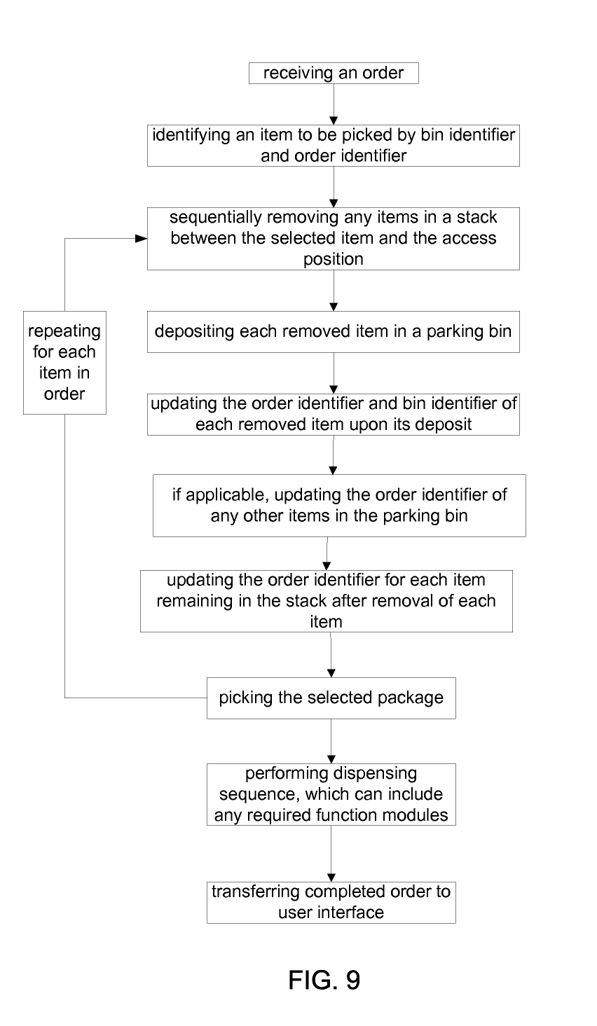

FIG. 10 is a schematic view of a pick head suitable for use in a method of the present invention with an extended platform.

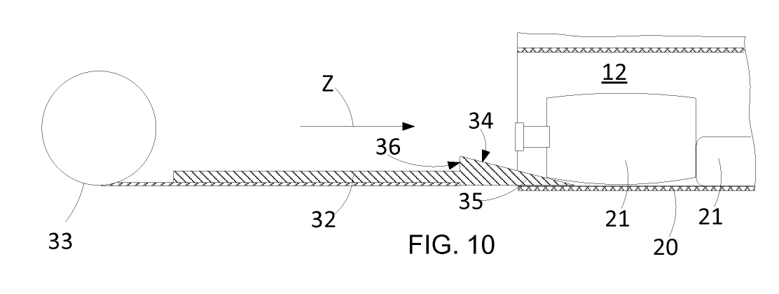

FIG. 11 is a perspective view of a pick head suitable for use in a method of the present invention with an unextended platform.

FIG. 12 is a perspective view corresponding to FIG. 11 but showing the pick head platform in an extended condition.

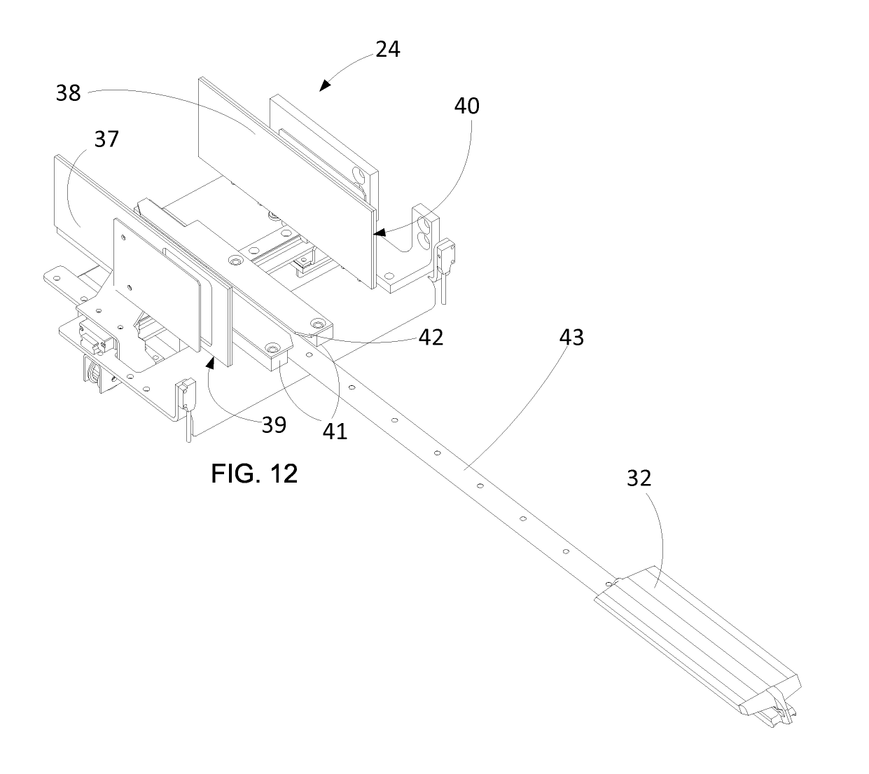

### DETAILED DESCRIPTION OF THE INVENTION INCLUDING THE PRESENTLY PREFERRED EMBODIMENTS

The methods, apparatus and systems of the present invention while not particularly limited in their application, are particularly suitable for use in a networked system such as is described in Applicant's co-pending PCT application serial no. PCT/CA2007/001220, the contents of which are incorporated herein by reference. The system described includes a server, a database of patient information linked to the server, a first client having input means linked to the server and operable to generate a script for a medicament prescribed to a user, a second client comprising an automated apparatus for dispensing medicaments (referred to in said PCT application as a robotic prescription dispensary) operable to recognize a human and/or machine readable description in the script, and to provide validating cross-referencing between the description and patient information as a prelude to dispensing a drug to the user on the basis of the input script. A doctor in a clinic can be a third client having input means linked to the server to input appropriate prescription information, or accept certain prescription information from the database as being applicable in the particular case for a particular patient. Further, the doctor's client device can be operable to display patient information, e.g., drug history, insurance coverage, etc., and a printer module can print the script as a paper print-out. The server and database enable storing, compiling and retrieval of patient data including name, address, and diagnostic and drug history. Access to the database can be provided to both the doctor and the automated apparatus for dispensing medicaments via the server, via a secure connection, or via a link between the system and a clinic's existing clinic management system or patient database.

The apparatus described in PCT/CA2007/001220 can also include a user interface, a teleconferencing or video-conferencing means enabling communication between the user and a human validation agent, and a scanning means for capturing an image of the script so that, if needed, it can be viewed by a human validation agent, such as a licensed pharmacist communicating in the system and with the apparatus from a remote location to the apparatus, to approve a prescription. An authentication means confirms the identity of the patient. Once the patient is recognized, the dispensing apparatus prompts the user for a script and the apparatus processes the user-input script either by the above-mentioned human validation agent or by processing the machine readable description (which may be a bar code). This information can be verified with the server and the database. The apparatus may also interface with the server to adjudicate insurance claims and to determine amounts payable by patients. The patient either accepts or rejects the transaction. If the transaction is accepted, the apparatus interfaces with the server to transact a payment, for example, by prompting the patient for credit card information. Prescription labels and receipts are printed. The apparatus confirms that the drug is correct and delivers it to a dispensing area for retrieval by the user while retaining the script in a lock box, and verifying that the purchased drug product has been retrieved. Further, the apparatus may print and/or provide to the user educational materials relevant to the medicaments that have been dispensed. The automated dispensing apparatus is of significant value in enabling a patient to obtain prescribed medicaments without having to attend a pharmacy or drug store.

The apparatus, methods and systems of the present invention may be used to store and dispense a variety of items but, for the purpose of illustration, will be described with reference to packages for medicament dispensary kiosks, the packages embodied as any of bottles, blister packs, boxes, etc., and containing drugs or other medicaments. In this specification, the term “medicament” encompasses drugs and any and all other materials dispensed subject to presentation of a prescription. Medicament packages may have a range of shapes and sizes depending on the size of the medicament to be dispensed and depending also on the particular packaging practices of the medicament supplier. Because space in such a kiosk is at a premium, ideally a dispensary bin size for a particular medicament package should closely match the size of package. Because the distribution of package sizes will normally vary from kiosk to kiosk, in a preferred embodiment, the bin racks are tailored for the particular kiosks in which they are to be installed.

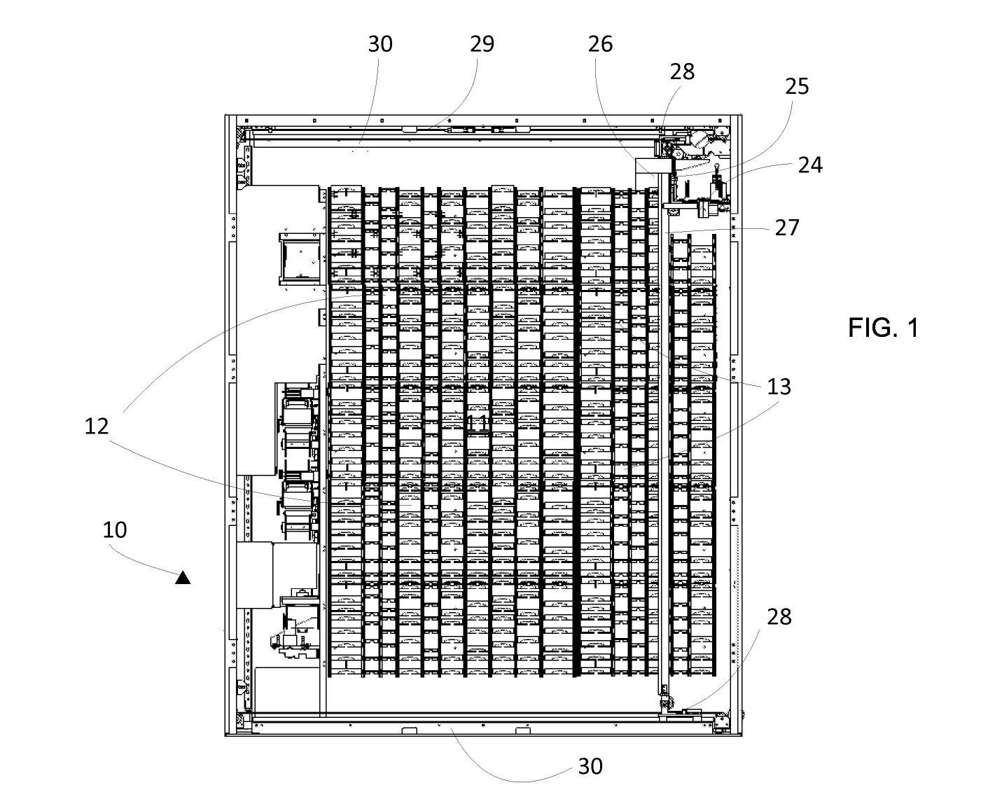

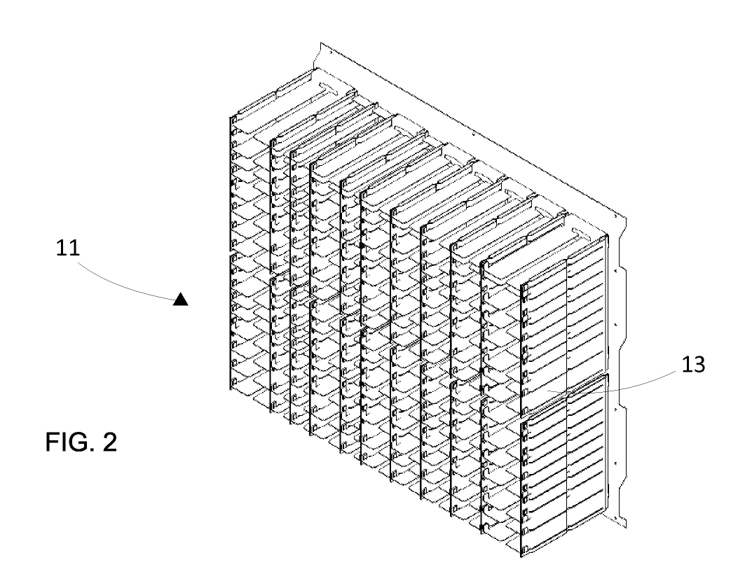

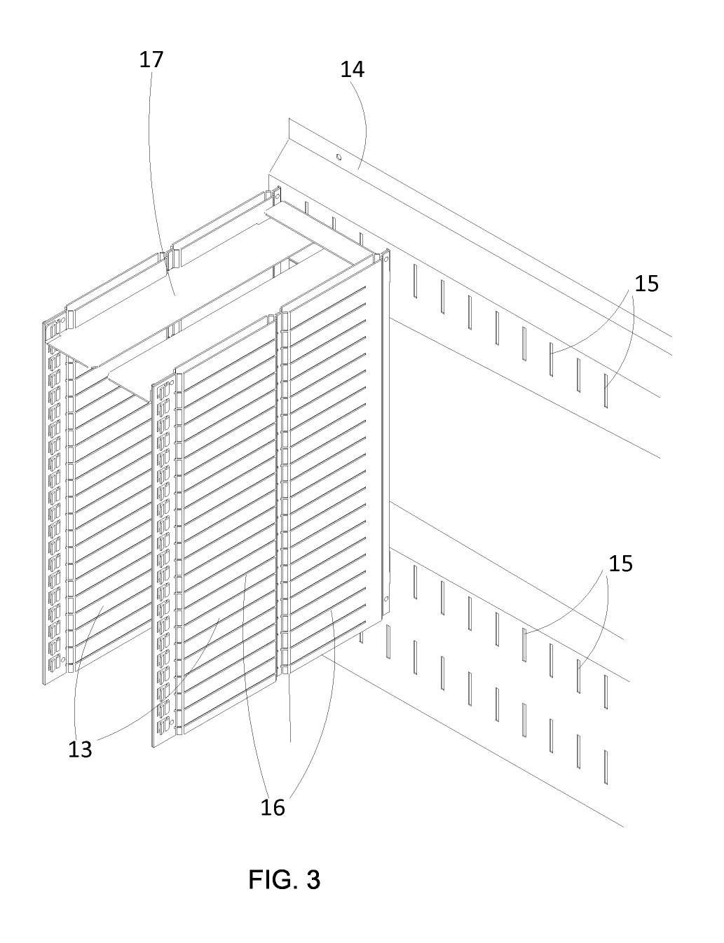

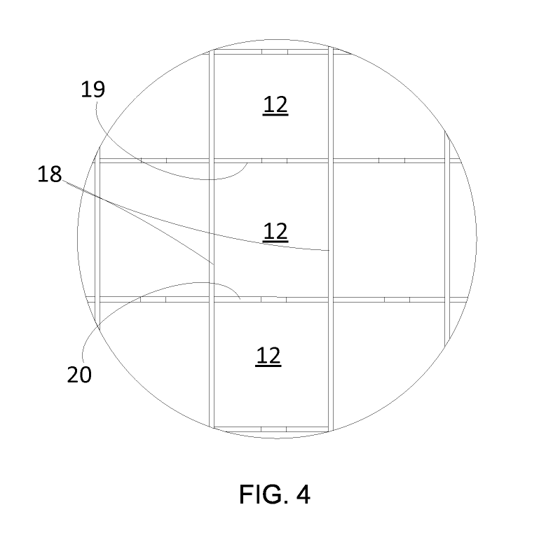

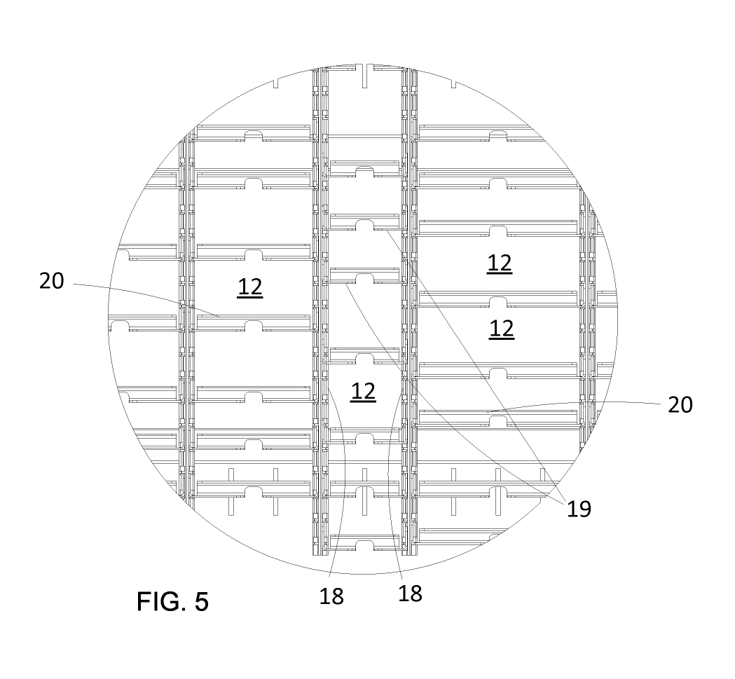

Referring to FIGS. 1 and 2, there is shown a cabinet 10 for a dispensing kiosk, the cabinet having a rack 11 of storage bins 12 arranged in a row and column array. As shown in FIG. 3, the rack 11 has a series of vertical partition members 13 mounted on a back panel 14 at vertical slots 15. A series of horizontal slots 16 permit the insertion of horizontally extending partition members 17. As shown in FIGS. 4 and 5, each bin 12 has a pair of side walls 18 comprising a part of respective partition members 13, each of the side walls of the inner ones of bins 12 also forming a side wall 18 of an immediately laterally adjacent bin. Each bin 12 has upper 19 and floor 20 members, with the lower floor member 20 of one bin forming an upper floor member 19 of an underlying bin. As will be appreciated, in the arrangement shown in FIG. 5, the size of bins 12 can be varied at the time the kiosk rack is configured by varying the distance between partition members 13 and between horizontal members 17. The bins 12 have a range of shapes and sizes to accommodate a range of differently sized packages to be dispensed. In one embodiment, the rack 11 is formed as a secure back end medicament storage vault which may be made more or less secure depending on the application to which the methods, apparatus and systems of the present invention are put. The storage vault can, in use, be combined with a front end unit (not shown) which bars unauthorized access to the storage vault, but which is opened to expose the vault for servicing. Mounted in the front end unit is suitably an interface unit (not shown) at which a user, can enter data, communicate with a remote expertise or data records through a data or teleconference link, collect dispensed packages, etc.

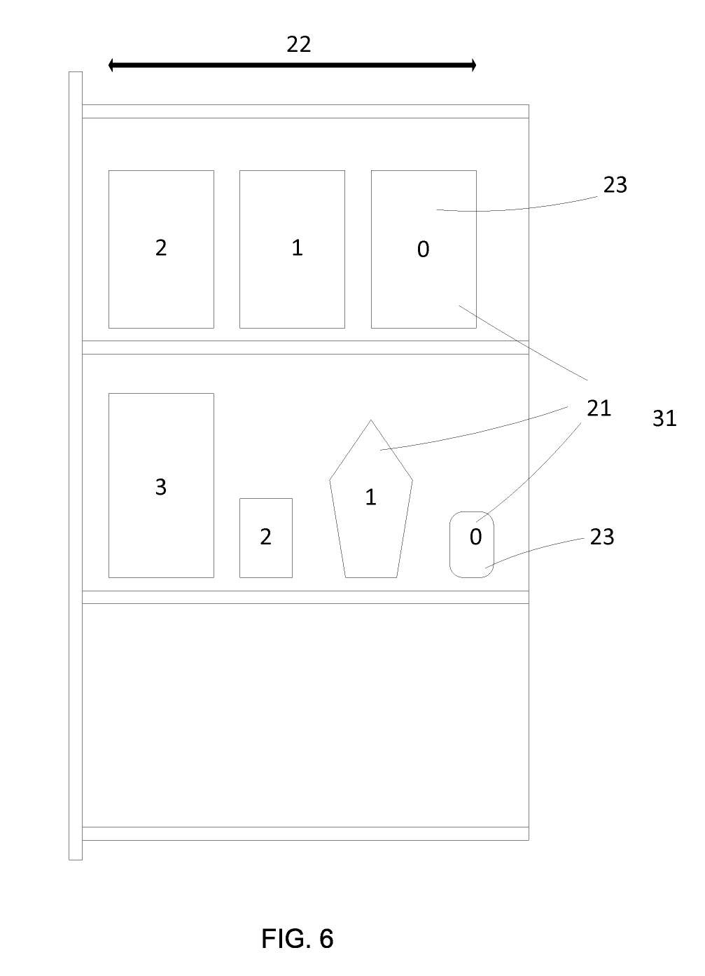

To optimize storage, each of the rack bins 12 must be large enough to accommodate the packages to be stored in that bin but preferably without leaving any significant unoccupied space in the bin. Packages 21 in a bin are normally stored in a stack 22 which may be a front-to-back stack as shown in FIG. 6 or another type of stack, such as a vertical stack or a side-to-side stack. The packages of a stack can be of identical size and/or shape or can be of different size and shape. However, for effective use of space, the size of packages should closely match the size of the bins containing them.

One position in the stack is an access position 23 from which a package is picked for removal from the bin. In a preferred embodiment, each bin has a single access position for several storage positions. However in another embodiment of the invention (not shown) in which a stack can be accessed from both a front face of the rack and from a back face of the rack, the arrangement may include more than one access position. In the case of a front-to-back stack, the access position is at a position corresponding to the foremost storage position of the packages stored in the bin. In a vertical stack, in another embodiment of the invention, the access position corresponds to the position of the bottom or top package of the stack.

To pick a package from a bin, a pick head 24 is driven by a pick head driver in X and Y directions to a desired XY position corresponding to a selected bin. As shown in FIG. 1, the pick head 24 is mounted on a vertically reciprocable carriage 25 which is driven by a belt drive 26 along a vertical guide rail 27. The rail 27 is mounted between two linked, horizontally reciprocable carriages 28. The carriages 28 are driven by a belt drive 29 along horizontal rails 30. The carriages 25 and 28 are movable in a plane which extends parallel to a front access side 31 of the bin rack 11 as shown in FIG. 6. In this way, the pick head 24 can be placed adjacent any selected one of the bins 12 at the front access side of the bin rack.

The pick head mechanism includes a platform 32 for supporting packages and a mechanism 33 for driving the platform into and out of a selected bin in the course of picking or placing a package in the bin. The platform 32 is moved in the Z direction to initiate picking a desired package from its position in the rack of bins and, if the package is part of a stack of packages, from its position within the stack, in preparation for dispensing the package or as part of another package handling procedure. Drive to the platform can, for example, be a scissors type telescopic supporting linkage or a wound tape rule as described in co-pending U.S. patent application Ser. No. 12/503,989 the contents of which are incorporated herein by reference. Platform 32 has a cam formation 34 which moves along a slot in the floor of the bin as the pick head moves in the Z direction into the bin to lift packages stored in the bin from the bin floor and to allow a leading edge 35 to slide under a package. The package then drops over cam 34 and is subsequently withdrawn as the platform 32 is withdrawn, the package being driven by its engagement with shoulder 36. The operation is repeated to move additional packages out of the bin and onto the platform if required. In one embodiment, platform 32 includes a sensor for monitoring the number of packages that pass over cam 34, i.e. the number of packages that are picked from that bin.

The pick head driver is controlled by a controller (not shown), suitably a programmed computer. The controller receives a command as part of a drug dispensing or other package handling procedure, which command is generated, for example, by processing a script, with results of the processing then being relayed to the controller. The controller signals to the pick head driver the position from which a package is to be picked as part, for example, of a dispensing procedure.

If the desired package to be retrieved by the pick head is stored in a position other than the access position, it must be moved to and through the access position in order for its removal from the bin. By the method of the invention, once the package to be selected has been identified and is monitored not to be at the access position, it is brought to the access position by a constrained manipulation of the stack, whereupon the selected package is picked by the pick head 24 for removal from the bin. As part of the picking procedure and in the case of the front-to-back stack, once the desired package is identified—say the third of four packages extending back into the rack bin 12 from access side 31—the pick head 24 is operated to pick the foremost package and to move it to a parking bin which has room for storing the picked, unwanted package. The procedure continues with the second unwanted package then being picked and parked. This reveals the desired package which is picked and enters a dispensing or other package handling procedure. Once the picking of the selected package is finished, the parked packages can be returned from their parking positions to the bin from which they had been removed, i.e. the packages are put through a reversal of the constrained manipulation. Alternatively, some or all of the parked packages are left where they are parked. In each case, the data record is updated. This process of package picking can be repeated when multiple packages are to be dispensed or subjected to another package handling procedure.

While back to front stacking is particularly accommodating of odd shaped packages, the methods of the present invention are also applicable to vertical stacks, to side-to-side stacks, and to cubic stacks: i.e. having component stacks in all three dimensions.

In the course of a pick procedure, the controller communicates with an indexing module that stores representations of bins and packages. The controller and indexing module may be integral or separate components. The indexing module stores parameters relating to each bin's location, dimensions and status (e.g. enabled/disabled, reserved for load/discard, etc). Each bin is identified by a unique name that contains the block, column and row it is located in. The bin representation is an exact analog of the physical bin; it can be empty or contain any number of packages.

The indexing module also stores a representation of each package in the vault in a database, with parameters which include location in the vault and any or all of medication type, age and/or expiry date of the medication, package dimensions, appearance (image), dose size, quantity of doses, DIN and UPC. The location is represented by two fields: bin identifier, which corresponds to the unique bin name, and order identifier (or stack order), which indicates how many packages are located between the package and the access position. In one embodiment, the unique name and bin identifier are the same. In a preferred embodiment, the order identifier is an integer. For example, in a preferred embodiment where the access position is at the front of a stack, an order of 0 means that a package is immediately accessible (at the front of the stack), while an order of 2 means that two packages have to be moved in order to access it. As will be apparent to a person skilled in the art, other integers could be used. For example, 0 (access position), 100 (first package), 200 (second package) or 0 (access point), −1 (first package), −2 (second package) or 1 (access point), 2 (first package), 3 (second package). The measured depth position of a package in a bin is generally not relevant to this controller function, since during the physical pick operation in a front-to-back stack, all packages are pushed against the back before the front one is picked, and during a place operation the package is left at the front of the bin. In this regard, it will be apparent to a person skilled in the art that while reference is made to an “access position”, this position is not a fixed location within the bin; rather it is a position assigned to a package based on stack order. As will be apparent to a person of skill in the art, where there is more than one stack in a bin, a further identifier will be required e.g. left stack/middle stack/right stack.

Having reference to the example above where the access position is at the front of the stack and an order of 0 means that a package is immediately accessible, while an order of 2 means that two packages have to be moved in order to access it, immediately after the mechanical pick is complete, the controller sets the package's bin identifier to a blank value, leaves its stack order at 0, and decreases the stack order of any packages in the same bin by 1.

Immediately after the mechanical place is complete (i.e. the removed package is deposited in a parking bin), the controller increases the stack order of any packages in the parking bin by 1 then sets the placed package's bin identifier to that of the placement bin.

When a package to be dispensed is located behind other packages in a bin, the packages in front are first moved to other locations in the vault, and then the requested package is picked. In order to determine which bin to place a package in, the controller obtains a list of all bins in which the package would fit (considering both physical dimensions and current contents of each bin) and ranks it by certain criteria. In one embodiment, these moves are permanent; the blocking packages are not returned to their original bin after the requested package is dispensed, and if they are later requested for dispense, they will be picked from their new locations. In another embodiment, a temporary parking bin mechanism is implemented at the pick head, such that a non-selected package is picked and held at the temporary parking bin on the pick head until the selected item is picked and is then returned to the original bin or delivered to another bin either before or after the selected package enters a dispensing or other handling sequence.

In the illustrated embodiments of the invention, the pick head is not designed to pick more than one package in a single operation. However, it will be appreciated that the pick head and the indexing scheme can be configured to enable picking of more than one package in a single operation of the pick head. In this case, the access position can, for example, be considered as an access position occupied by two or more packages to be removed simultaneously either to be parked or to be subjected to a dispensing or other package handling procedure.

Methods involving vertical and side-to-side stacks for storing packages in a bin are also included in the present invention. In the case of a vertical stack, the stack is preferably stacked from the top and picked from the bottom. At both top and bottom, the package can be slid in (top) and slid out (bottom) but at all other positions, the stack members are preferably prevented from extraction, for example, by a lip at each side of the bin. The controller picks from the bottom of the stack and places on top of the stack any unwanted package if there is not also any front-to-back stacking. If there is front-to-back stacking, then the vertical stacking control has to be integrated with the front-to-back control previously described.

A side-to-side stack functions in a similar way as the vertical stack, although there is no gravity acting down through the stack. Suitably a mechanical component fulfills a similar function by applying a force to move the stack sideways e.g. a biasing member or extendable rod and push plate. The mechanical component is temporarily withdrawn from its position pushing at the end of the stack opposite the access position whenever a new packages is to be placed in the stack, while picked packages are picked from the opposite end of the stack (at the access position). Intermediate packages in the stack are prevented from being picked e.g. by a bottom lip. As in the vertical stack arrangement, if there is front-to-back stacking, then the side-to-side stacking control is integrated with the front-to-back control previously described.

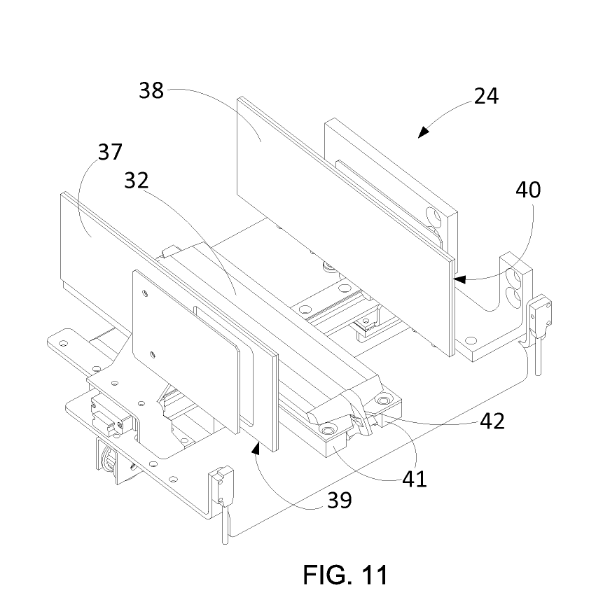

The pick head mechanism, in addition to being used for picking packages from bins, also functions as a place head mechanism for loading packages sequentially into bins and a corresponding package manipulation procedure is implemented. In a placing operation for a front-to-back stack, a platform bearing a product to be loaded is driven into a selected bin 12 and the platform 32 is then withdrawn without, however, withdrawing the borne package. As shown in FIG. 11, upon withdrawal of the platform, barriers 37 and 38 prevent withdrawal of the package The barriers are mounted to enable a spacing between them to be increased to allow passage of platform 32 during forward movement of the platform and the package into the bin, the spacing then being reduced to allow passage of the platform, but not the package from the bin. The platform 32 slides under lower edges 39 of plates 37 and 38 into an unextended position in the pick head while the package which has been loaded in the selected bin is blocked from exiting the selected bin by vertical edges 40 of plates 37 and 38. The plates have adjunct functions to both grip a package which has been picked from the bin rack when the picked package reaches a desired position in the pick head and also to centre the package in the pick head. Other barriers or gripping mechanisms performing the same function would also be suitable. The placed package is given an order identifier corresponding to the access position (e.g. 0) and the order identifier of each other package in the bin is adjusted accordingly (for example, where the packages are identified by ascending integers such as 0, 1, 2, 3 etc. the order identifier of each of these packages is raised by 1.)

In the case of a vertical stack a similar concept applies, but an alternative barrier arrangement is implemented to prevent withdrawal of packages other than the desired package. One form of barrier comprises a lip on the front of the bin. In a placing operation, the package is deposited at the top or bottom or the stack. At the top of the stack, the package is given the order identifier corresponding to the package furthest from the access position. Where the package is deposited in the access position, the placed package is given an order identifier corresponding to the access position (e.g. 0) and the order identifier of each other package in the bin is adjusted accordingly (for example, where the packages are identified by ascending integers such as 0, 1, 2, 3, etc. the order identifier of each of these packages is raised by 1.

In the case of a horizontal side-to-side stack, the access position can be at one end of the stack. In order for a package to be placed, the arrangement is configured to present a space for its insertion. This space is maintained through use of a bias member to bias the packages in the stack towards the access position end of the bin. When a package is to be inserted, the bias member is released to leave a space for the package to be inserted. The bias mechanism can be triggered to withdraw by an engaging mechanism on the pick head mechanism and can be triggered to extend once again by disengagement and withdrawal of the pick head mechanism.

While in one embodiment, a package is selected on the basis of being the correct package type with which the least number of constrained manipulation steps are required to access the package, in another embodiment, the selected package is the oldest package of the correct package type or if there are multiple most aged packages of the correct type, then the package within that group with which the least number of constrained manipulation steps are required to access the package.

In the case of placing packages, in one embodiment, prior to placing a new package, any older packages of the same type already in the stack are brought closer to the relevant access position through constrained manipulation steps, while the new package is placed further from the access position. Where a new package is placed in the access position e.g. as may be the case in a front to back stack, either immediately after placement a constrained manipulation of steps can be performed to move the new package to a position further from the access position and to move older package(s) of the same type closer to the access position or, alternatively, this step may be performed as part of a picking process. In both cases, the order identifiers of the placed and moved packages are updated accordingly.

In the illustrated embodiments, the picking of a package has been described as normally taking place in the context of a dispensing procedure. However, picking and placing may occur in the context of other package handling procedures such as discarding packages which are beyond their expiry date, are the subject of recall, or have been subjected to unacceptable environmental conditions or damage. As a result, packages are deposited in a discard bin or receptacle, rather than in a parking bin. In a further procedure, picking and placing of packages are effected to optimize product storage. Thus, for example, during an idle time, an application is run to determine if product storage is optimal and, to the extent the storage is not optimal, certain packages are picked and placed elsewhere both as to bin placement and as to stack order. In particular, products that are high sellers or which are getting close to their expiry date are placed at positions where the least manipulation will be required if the products are subsequently chosen for dispensing. For example, in the case of a front-to-back stack, packages corresponding to a product most likely to be chosen are parked at the front of the stack.

Although in the preferred embodiments described herein, the bins 12 are located in a rack as an array of rows and columns, other arrays are possible such as a radial array or a diagonal array and the bin shapes can be other than rectangular.

In the illustrated embodiments, each bin is confined by two side walls and a top and bottom wall (i.e. ceiling and floor). It will be appreciated that all four walls may be configured in any convenient manner provided that the walls confine a stack of packages. In an alternative embodiment, physical side walls are dispensed with and the stacks of packages are confined by virtual walls, in the sense of the walls only really having a reality within the context of the positioning data. In this case, a package is picked or placed from or to a prescribed location on a rack shelf with adjacent stacks supported on the shelf separated by a small space but not divided by a wall.

A kiosk for medicament packages can suitably include other function modules, for example, a pill counter (not shown), which may fulfill the functions of a pill hopper, singulator and dispenser whereby a required number of pills can be delivered for picking and dispensing by a pick head. Another form of function module (not shown) is a bulk material storage element used to reconstitute, mix, and/or cause a reaction between, bulk materials for subsequent pick of a prepared medicament from the module. A further form of function module (not shown) comprises a dilution unit to dilute a medicament concentrate with water or other diluents at the time of medicament dispensing. In use, the pick head described above with respect to the picking and loading of medicament packages can have an additional actuating means to actuate the function to be performed at each of the installed function modules. It will be understood that the number and type of function modules can be tailored to the particular type and number of functions to be performed. In the case of an order with multiple packages, the function module may be engaged upon each package being picked or all packages may be picked and then the appropriate function modules may be engaged.

Prior to dispensing, a picked package is suitably subjected to a validation sequence to verify that the correct package has been selected—this might be by reading of a bar code, cross-referencing sensed package properties with recorded package properties, or a visual verification, which could be performed remotely e.g. by a professional pharmacist. The picked package may also be subject to a labelling step.

Some or all of the storage bins and/or function modules may be located in a zone of the bin rack which is at room temperature, while others may be located in a controlled temperature section such as a refrigerated zone for proper storage of medicaments that are prone to deterioration at room temperature.

Other variations and modifications will be apparent to those skilled in the art. The embodiments of the invention described and illustrated are not intended to be limiting. The principles of the invention contemplate many alternatives having advantages and properties evident in the exemplary embodiments.

1. A method for picking an item from a storage apparatus comprising a rack of bins, each bin having a bin identifier identifying its position in the rack and each bin accommodating one or more items, wherein multiple items in a single bin are arranged in a stack and each item in a stack has an order identifier corresponding to its position in the stack, the method comprising:
a) identifying an item to be picked by its bin identifier and order identifier;
b) removing items of the stack between the item to be picked and an access position of the stack and parking the removed items until the item to be picked is in the access position;
c) removing the item to be picked; and
d) updating an index of order identifiers and bin identifiers to match the repositioning of the items.

2. A method as claimed in claim 1, the rack comprising a row column array of bins, the method further comprising removing an item by inserting a pick head into the selected bin to engage the item and withdrawing the pick head from the selected bin.

3. A method as claimed in claim 1 wherein the removed items are parked in a bin other than the selected bin.

4. A method as claimed in claim 2, the stack in at least one of the bins being a front-to-back stack.

5. A method as claimed in claim 4, wherein the access position is at the front of the stack and items are placed into the stack at the access position.

6. A method as claimed in claim 5, wherein the pick head pushes all items against a back of the bin prior to engaging an item.

7. A method as claimed in claim 1, the stack in at least one of the bins being a vertical stack.

8. A method as claimed in claim 7, wherein the access position is at the bottom of the stack and items are placed into the stack at the top of the stack.

9. The method of claim 3 wherein each removed item other than the time to be picked is deposited in another storage bin and its bin identifier is correspondingly updated and the order identifier of any item in the other bin is correspondingly updated.

10. A method as claimed in claim 1, wherein at least one of the bins contains more than one stack.

11. The method of claim 10, wherein the stacks are the same or different and are selected from a front-to-back stack, a vertical stack and a side-to-side stack.

12. A method as claimed in claim 1, wherein the item to be picked, when removed from the selected bin, is placed into an inspection bin.

13. A method as claimed in claim 1 wherein the rack includes at least one bin having a floor, a ceiling and virtual side walls.

14. A method of handling items at an automated dispensing comprising:
a) receiving an order for a selected item;
b) picking the selected item according to the method of claim 1; and
c) transferring the picked item to a user.

15. An apparatus for storing and dispensing items, comprising:
a rack of bins, each bin accommodating one or more items, wherein multiple items in a single bin are arranged in a stack;
a pick head and a pick head driver for driving the pick head to an access position in a selected bin, wherein each item in a stack is assigned an order identifier corresponding to the number of items between it and the access position;
an indexing module for storing for each item a bin identifier corresponding to the bin in which the item is positioned and an order identifier corresponding to the number order of the item in the stack in which the item is positioned;
a controller for receiving orders for items and signalling the pick head driver to select an item by bin identifier and order identifier;
wherein the controller is operable to:
a) identify a selected item to be picked from a stack thereof by a selected bin identifier and a selected order identifier;
b) drive the pick head to remove items of the stack between the item to be picked and an access position for the selected bin and to park the removed items;
c) drive the pick head to remove the item to be picked; and
d) update an index of the order identifiers and the bin identifiers to match the repositioning of the items.

16. The apparatus of claim 15 wherein the stacks are arranged front-to-back and the access position is at the front of a stack.

17. The apparatus of claim 15 wherein the controller is further operable to park each removed item in a bin other than the selected bin.
